(19) United States
(12) Patent Application Publication
(10) Pub. No.: US 2002/0100037 A1
(43) Pub. Date: Jul. 25, 2002

(54) Device and method for downloading software via a network

(76) Inventor: Eiichiro Kitagawa, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/051,081

(22) Filed: Jan. 22, 2002

(30) Foreign Application Priority Data
Jan. 23, 2001 (JP) 2001-015006

(51) Int. Cl. G06F 9/445

(52) U.S. Cl. 717/174

(57) ABSTRACT

A software sale and distribution method is implemented by using inexpensive media and by a facilitated user operation, while the cost of a device therefor is reduced. By storing, in a portable information storage medium loadable into an information processing device connected to a network and in which software is downloaded from the network and is executed, identification information on the software, information on the location on the network of the software, and secret information related to a user who uses the software, the software can be executed after being automatically downloaded from a server terminal, without requesting a user to perform an operation. This enables a system for which a right-to-use software can be sold, which is stored in a small-capacity, low-cost portable information storage medium.

### BACKGROUND OF THE INVENTION

1. Field of the Invention

The present invention relates to a device and method that use a network to download software.

2. Description of the Related Art

Various types of payware adapted for use in personal computers (PCs) and game machines are known. The most common form of payware is the so-called “package sale”, in which software written in media such as a floppy disk and a CD-ROM is sold. However, recently, with widespread use of the Internet, download sales have come into use, in which, by establishing a link to a network, software is downloaded from a server.

The most ordinary method in which software is downloaded from a network is as follows:

A user searches for a site for software the user desires to use; the user operates a Web browser to connect to the Web server of a site found by the search; the user enters a credit card number into a displayed page in order to pay a charge, and subsequently initiates downloading to store the software in a local terminal.

The following software-downloading methods have also been proposed.

For example, Japanese Patent Laid-Open No. 11-143719 discloses a public download system. In this system, a user loads a recording medium, which contains a download ID, into a download terminal linked to a server via a communication link, and data based on the ID is downloaded from the server and is written on the recording medium by the download terminal.

According to Japanese Patent Laid-Open No. 09-288576, software is distributed beforehand to a user in a form in which it is stored on a recording medium protected by a secret code. A right code for enabling the software to be available for only a user-purchased time is distributed to a terminal for the user by computer communication.

According to Japanese Patent Laid-Open No. 2000-092004, after a user who desires a service makes a contract with a broadcasting center to use software, a portable storage device that contains usable software information, including user-identification information given under the contract and a list of usable software names is sent from the broadcasting center to the user's home. Software transmitted from the broadcasting center is received and is used by the user's terminal. Accounting information in accordance with how much the software is used is transmitted to the broadcasting center, and the user is charged based on the contract.

Although package sales allow users to easily acquire software without anxiety or special knowledge, there is a problem in that, since the size of software increases year after year, media for storing the software must have a high capacity for storage.

In a method in which software is distributed after being stored on high-capacity media such as a CD-ROM, the cost of the media itself is relatively inexpensive, but the price of a reader device such as a CD-ROM drive is expensive. Accordingly, the method has a problem in that the cost of the reader device is high.

In the case of storage media such as a Compact Flash (CF) card, a reader device can be inexpensively made, so that the cost of the reader device is low. Nevertheless, the cost of unit capacity of CFs is high, which causes a problem in that use of high-capacity software greatly increases the cost of the media.

An ordinary download-sale form has a problem in that a user must perform complicated operations in which the user searches a network for a desired download site, enters the URL of the found site, and enters a credit card number. The user may also feel anxious about entering the credit card number.

In the system of Japanese Patent Laid-Open No. 11-143719, the downloaded data is written on the recording medium containing the download ID. Thus, the recording medium, which is retained by the user, must have a large capacity matching the size of software to be downloaded. This causes a problem in that the required cost is high.

In the case of Japanese Patent Laid-Open No. 09-288576, it is required that a reader device be capable of reading a medium such as a CD-ROM, which is distributed beforehand. A CD-ROM drive is more expensive than a card reader, etc. Accordingly, there is a problem similar to that of package sales in that the expensiveness increases the required cost.

In the case of Japanese Patent Laid-Open No. 2000-092004, discussed above, it takes a lot of time to obtain software because the user must make a contract beforehand. In addition, since an IC card is sent, based on the contract from the broadcasting center, in a form that contains user identification information, it is purchased and carried by the user. Accordingly, there is a problem in that the user is unable to use the IC card immediately.

### SUMMARY OF THE INVENTION

In view of the foregoing problems, it is an object of the present invention to provide an information processing device and method, and a software distribution system in which software is distributed for sale both by using inexpensive media and by a facilitated user operation, while the cost of the device is minimized.

It is another object of the present invention to provide a portable information storage medium used with the above device, method, and system.

According to an aspect of the present invention, there is provided a portable information storage medium loadable into an information processing device connected to a network, which executes software that is downloaded from the network. The portable information storage medium includes a storage area for storing identification information on the software, location information representing a location on the network at which the software is stored, and secret information on a user who uses the software.

According to another aspect of the present invention, there is provided an information processing device that includes a communication unit for communicating with a server terminal on a network, a portable-information-storage-medium connecting unit to which a portable information storage medium containing information on software to be acquired via the network is connected, an information transfer unit for downloading the software from the server terminal into an internal storage medium by using the communication unit, a software storage unit for storing, in a software storage area of the internal storage medium, the software downloaded into the internal storage medium, a software management unit for managing the software stored in the software storage area, and an external-storage-medium reading unit for reading predetermined information, which is written on the portable information storage medium, when the portable information storage medium is connected to the portable-information-storage-medium connecting unit.

According to another aspect of the present invention, there is provided a software distribution system for distributing software provided by a software provider to a user via a store. The software provider includes a server terminal, which is externally accessed via a network so that software is downloaded, a user-information-management database connected to the server terminal, and a file server terminal containing at least one type of software. The software provider supplies the store with a portable information storage medium containing a right of use of the software and information at the location on the network of the software. The store sells the portable information storage medium to the user. The user downloads and executes the software from the software provider after loading the purchased portable information storage medium into the information processing device.

According to another aspect of the present invention, there is provided an information processing method including a communication step for communicating with a server terminal on a network, a portable-information-storage-medium connection step for connecting to a portable information storage medium containing information on software to be acquired via the network, an information transfer step for downloading the software from the server terminal into an internal storage medium, a software storage step for storing, in a software storage area of the internal storage medium, the software downloaded into the internal storage medium, a software management step for managing the software stored in the software storage area, and an external-storage-medium reading step for reading predetermined information, which is written on the portable information storage medium when the portable information storage medium is connected in the portable-information-storage-medium connecting step.

Further objects, features and advantages of the present invention will become apparent from the following description of the preferred embodiments with reference to the attached drawings.

### BRIEF DESCRIPTION OF THE DRAWINGS

FIG. 1 is a block diagram showing an information processing device according to a first embodiment of the present invention.

FIG. 2 is a block diagram showing a structure of a software distribution system to which the first embodiment is applied.

FIG. 3 is a flowchart showing a process performed when software is downloaded.

FIG. 4 is a flowchart showing activation and termination of an application.

FIG. 5 is a flowchart showing a process performed when an application is downloaded, in a case in which a process for checking a device ID is checked.

FIG. 6 is a flowchart showing activation and termination of an application in a second embodiment of the present invention.

FIG. 7 is a flowchart showing a process from loading of a CF card 202 up to mutual authentication in a third embodiment of the present invention.

FIG. 8 is a flowchart showing a process from completion of mutual authentication up to activation of software in internal storage.

FIG. 9 is a flowchart showing a process performed when a version of software in a server 301 is newer in a third embodiment of the present invention.

FIG. 10 is a flowchart showing activation and termination of an application in a third embodiment of the present invention.

FIG. 11 is a flowchart showing activation and termination of an application in a fourth embodiment of the present invention.

### DESCRIPTION OF THE PREFERRED EMBODIMENTS

### First Embodiment

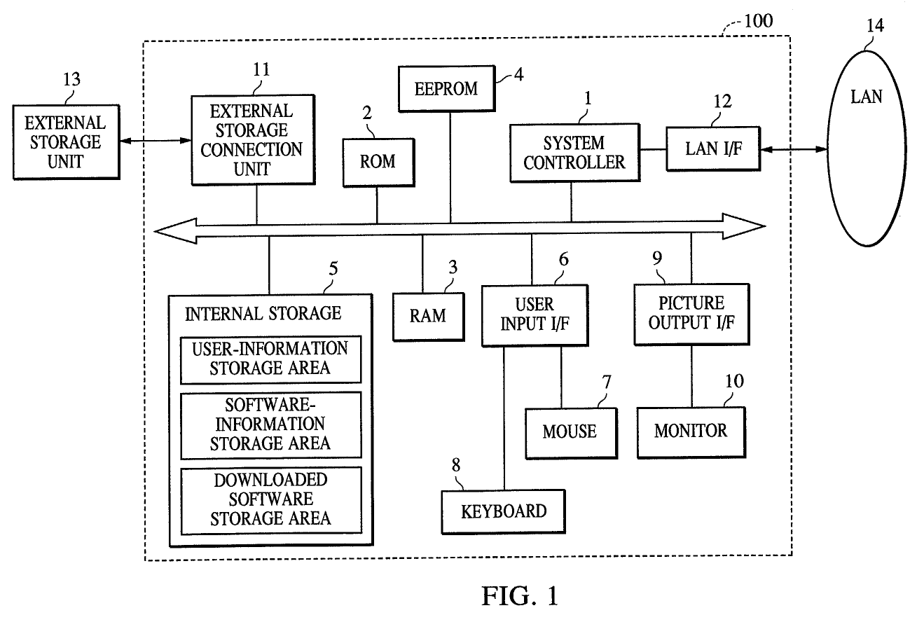

FIG. 1 shows the system structure of an information processing device 100 according to a first embodiment of the present invention. The information processing device 100 includes a system controller 1, a read-only memory (ROM) 2 for storing programs, a random access memory (RAM) 3 for temporarily storing information, an electrically erasable, programmable read-only memory (EEPROM) 4, an internal storage 5 for storing software and management information thereon, a user input interface 6, a mouse 7 and a keyboard 8, which are operated by a user, a picture output interface 9, a monitor 10, an external storage connection unit 11, and a local area network (LAN) interface 12.

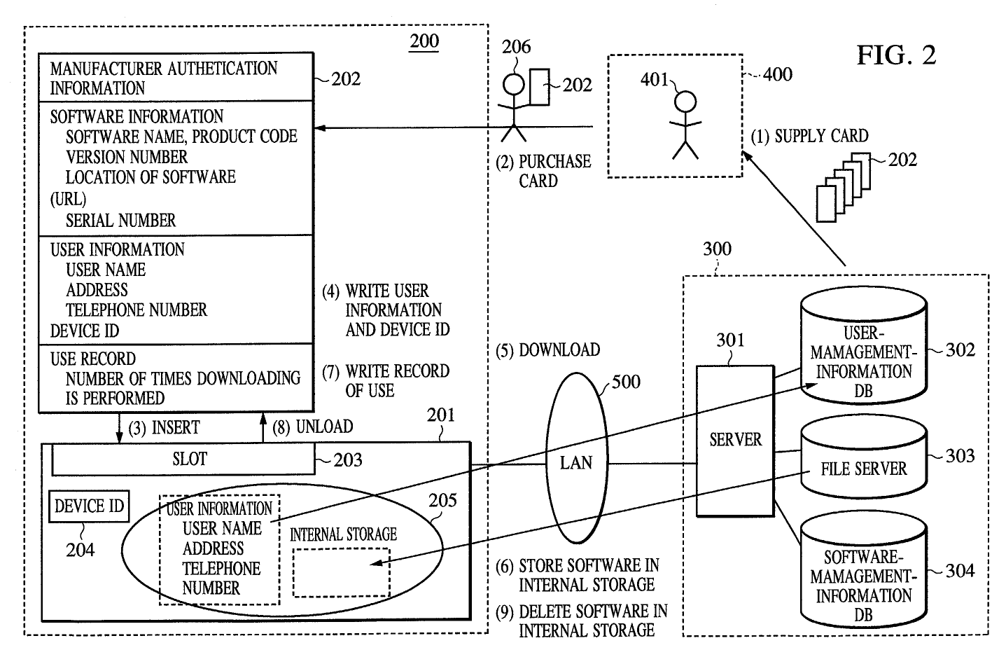

The LAN interface 12 is connected to a LAN 14. An external storage unit 13 is connected to the external storage connection unit 11. The external storage unit 13 represents, for example, a Compact Flash (CF) card 202 (in FIG. 2) in the first embodiment. Any type of readable and writable storage medium, such as a floppy disk or a SmartMedia, may be used as the external storage unit 13. The external storage connection unit 11 represents, for example, a CF-card reader.

When main power is supplied, a program is loaded and executed by the system controller 1. When the information processing device 100 is initially used by the user, a message instructing the user to input necessary user information is displayed on the monitor 10. The user operates the keyboard 8 to input the user information.

The inputted user information is received by the system controller 1 via the user input interface 6. The system controller 1 stores the input user information in the internal storage 5. The inputted user information includes a user name, an address, and a telephone number. When the user finishes inputting the user information, the information processing device 100 is set in a normal operating state.

The information processing device 100 not only executes a program stored in the ROM 2, but also can read and execute an application, which is stored beforehand in the internal storage 5, when the user operates the mouse 7 to select a process from a menu displayed on the monitor 10.

By also storing additional software in the internal storage 5, a new application can be executed by the information processing device 100. The process of storing an additional application is as follows: the user purchases an external storage unit 13 containing software at a store; the user connects the external storage unit 13 to the external storage connection unit 11; and by executing a program to install the software, the software is installed in the internal storage 5. After the installation, by reading the software from the internal storage 5, the software can be executed.

In an ordinary application-sale method as described above, the external storage unit 13 must have a large capacity required for storing the entirety of software, which increases the cost of the external storage unit 13.

In the first embodiment, the external storage unit 13 has a small capacity and simply enables storage of the identification information of the software and information on the location of the software on a network. The software itself can be downloaded from a server 301 (on the network), which is indicated by the location information stored in the external storage unit 13. The overall course summary of the downloading is shown in FIG. 2.

FIG. 2 shows a user's home 200, a software provider 300, and a store 400 as main members.

(1) The software provider 300 supplies the store 400 with a CF card 202 containing the software information.

(2) A user 206 goes to the store 400 and purchases the CF card 202 from a sales person 401. The CF card 202 contains manufacturer authentication information and software information, as shown in FIG. 2.

The CF card 202 is based on a known standard for small memory cards. The CF card 202 has a length of 36.4 mm, a width of 42.8 mm, and a thickness of 3.3 mm, and its weight is, for example, approximately 14 grams.

The CF card 202 contains at least the information required to reach the software, such as a software name, a product code, a version number, and a uniform resource locator (URL) as the location on the network of the software, and a serial number and a license key, which are information indicating that the user 206 is an authorized purchaser.

(3) The user 206 inserts the CF card 202 into a slot 203 of an information processing device 201 at the user's home 200.

(4) The information processing device 201 writes its device ID and user information in the CF card 202.

After that, the information processing device 201 uses a LAN 500 to access a server 301 of the software provider 300, which is indicated by the URL stored in the CF card 202.

(5) The information processing device 201 downloads the software from the server 301.

(6) The downloaded software is stored in internal storage of the information processing device 201.

(7) The information processing device 201 writes a use record in the CF card 202. The information processing device 201 executes the software.

(8) The user 206 unloads the CF card 202 after finishing the execution of the software.

(9) At this time, the software is deleted from the internal storage. In order for the user 206 to use the software again, the user 206 inserts the CF card 202 again, and the processing from step (3) is executed.

When the information processing device 201 writes the use record in step (7), it overwrites a number of times downloading is performed, which is written in the CF card 202, by a value in which one is added to the number.

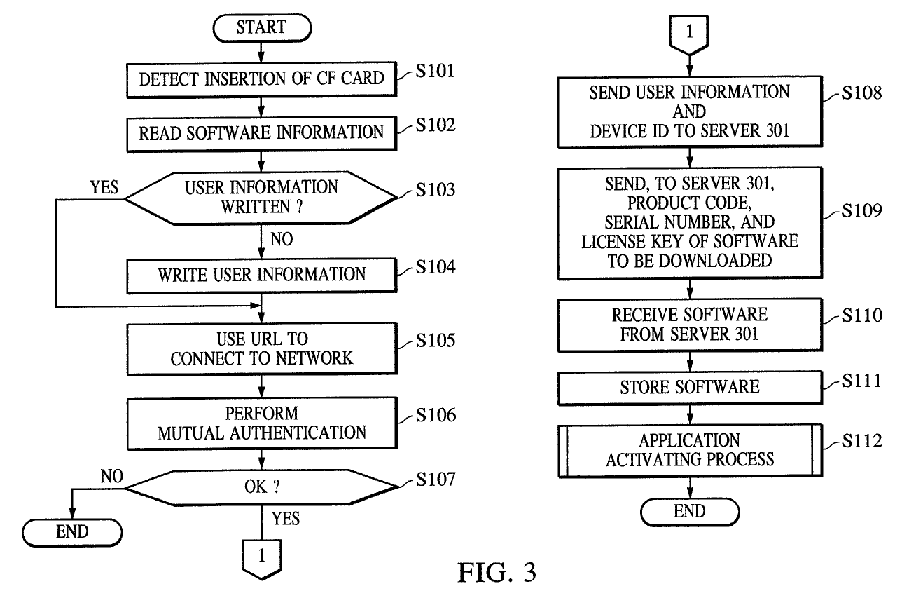

The overall course summary has been described. Next, with reference to FIG. 3, a process of the information processing device 201 from the insertion of the CF card 202 in step (3) to the deletion of the software from the internal storage 5 in step (9) is described below.

When the user 206 inserts the CF card 202 into the slot 203, in step S101, the external storage connection unit 11 (in FIG. 1) detects the insertion of the CF card 202. In step S102, the information processing device 201 reads and stores the software information and the location information in the internal storage 205 (in FIG. 2).

In step S103, the information processing device 201 determines whether or not user information set by the user 206 is written in the CF card 202. If the user information has not been written yet, the user information is read and is written in the CF card 202. In step S104, a device ID stored in the EEPROM (in FIG. 1) is written in the CF card 202, with the user information.

The process proceeds to connection to the network. In step S105, based on the URL information read from the CF card 202, a connection request is sent to the LAN 14 (in FIG. 1) via the LAN interface 12. The URL information designates the server 301 (in FIG. 2) operated by the software provider 300 (in FIG. 2). The information processing device 201 then is connected to the server 301.

In step S106, mutual authentication is performed by using manufacturer authentication information written in the CF card 202 and authentication information stored in the server 301. When mutual authentication is completed in step S107, the user information and the device ID are sent to the server 301 (in FIG. 1).

The server 301 stores the received information in a user-management-information database 302 (in FIG. 2). The server 301 may perform additional checking based on the received information, if required. In this embodiment, the server 301 checks nothing in particular, so the process proceeds to step S109.

In step S109, a product code, a serial number, and a license key are sent as software information on downloading to the server 301. The server 301 checks the received information by querying a software-managementin-formation database 304. If the received information is correct, software stored in a file server 303 is transmitted to the user information device 201.

In step S110, the user information device 201 receives the software from the server 301. In step S111, the user information device 201 stores the software in the internal storage 205 (in FIG. 2). After the downloading ends, the process proceeds to an application activating process in S112.

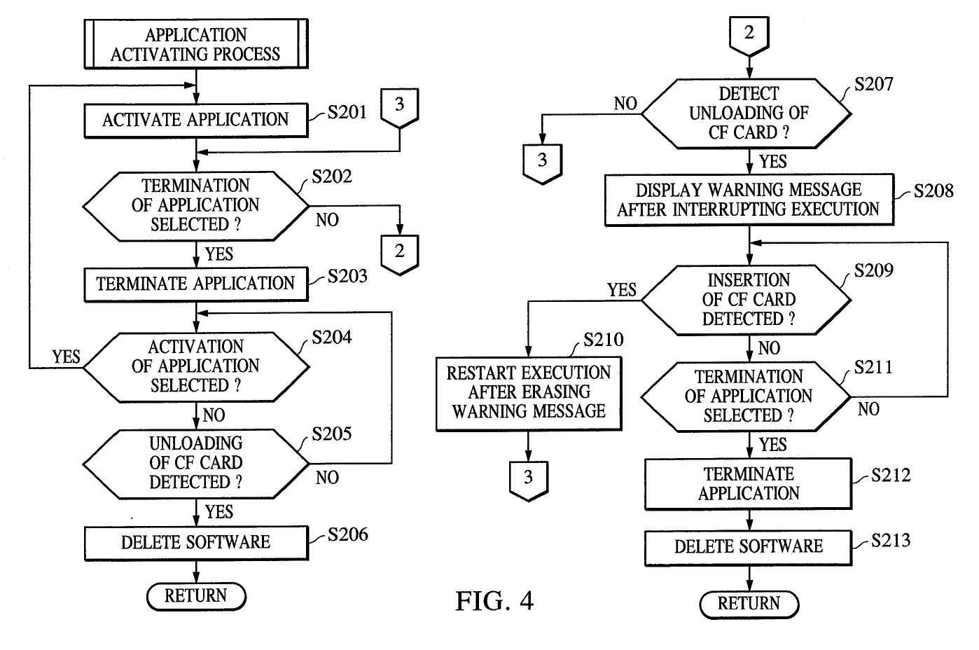

FIG. 4 shows the flowchart of the application activating process. In step S201, the software stored in the internal storage 205 (in FIG. 2) is loaded into memory and an application is activated. The user operates a mouse to operate the user information device 201, and uses the application while viewing a screen displayed on a monitor.

When the user operates the mouse to select termination of the application in step S202, the application is terminated in step S203. After that, when the user operates the mouse to select activation of the application again in step S204, the process goes back to step S201 and reactivates the application.

When the user unloads the CF card 202 without selecting the reactivation of the application, the unloading of the CF card 202 is detected in step S205. In step S206, the software (the application) is deleted, and the process goes back for termination.

In step S202, when termination of the application is not selected, the application is being continuously used. If the unloading of the CF card 202 is not detected, step S202 and step S207 are repeatedly performed.

When the user unloads the CF card 202 while the application is being used, the unloading of the CF card 202 is detected in step S207. In step S208, after the execution of the application is interrupted, a warning message, which warns the user either to insert the CF card 202 or to terminate the application, is displayed on the monitor, and a user-input-awaiting state is activated.

When the user inserts the CF card 202, the insertion of the CF card 202 is detected in step S209. In step S210, the warning message is deleted, and the execution of the application is restarted in step S210. The process goes back to step S202.

When the user operates the mouse to select termination of the application without inserting the CF card 202 after step S208, the insertion of the CF card 202 is not detected in step S209, and in step S211, it is determined whether or not termination of the application is selected. If termination of the application is selected, the application is terminated in step S212. In step S213, the software (the application) is deleted from the internal storage 205, and the process goes back for termination.

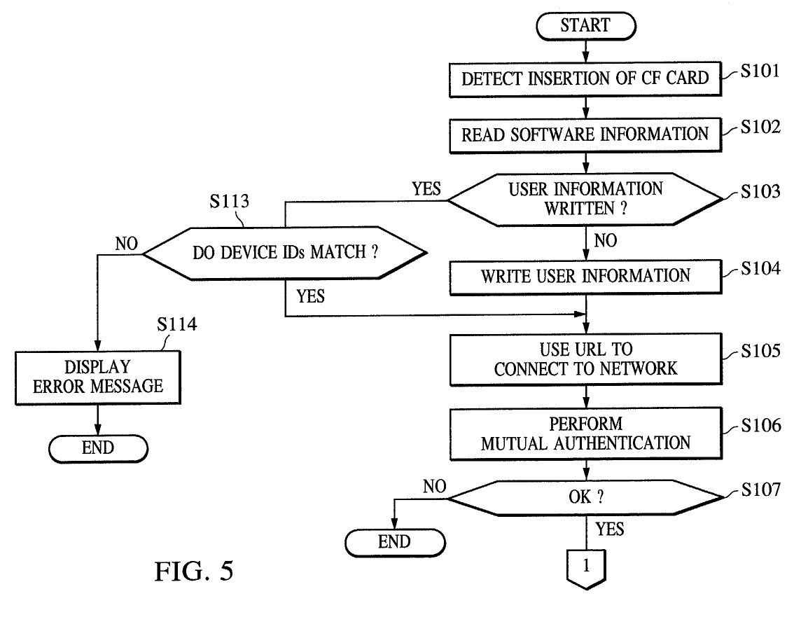

The device ID written in the above step S104 can be used for a security check function, as required. For example, by comparing the device ID written in the CF card 202 is compared with the device ID stored in the EEPROM 4 when the CF card 202 is read, and only when both device IDs match each other is it make possible to use the CF card 202. A process into which this process is incorporated is shown in FIG. 5.

The process in FIG. 5 differs from the process in FIG. 3 in a case in which the user information is written, and proceeds to step S113. In step S113, the device ID written in the CF card 202 is compared with the device ID stored in the EEPROM 4 and when both match each other, the server 301 designated by the URL is accessed via the network in step S105.

When both device IDs do not match each other, in step S114, an error message is displayed and the process is terminated. The newly provided Step S113 is used to establish correspondence between the CF card 202 and each user's information processing device, whereby use of the CF card 202 in a different information processing device can be prevented.

### Second Embodiment

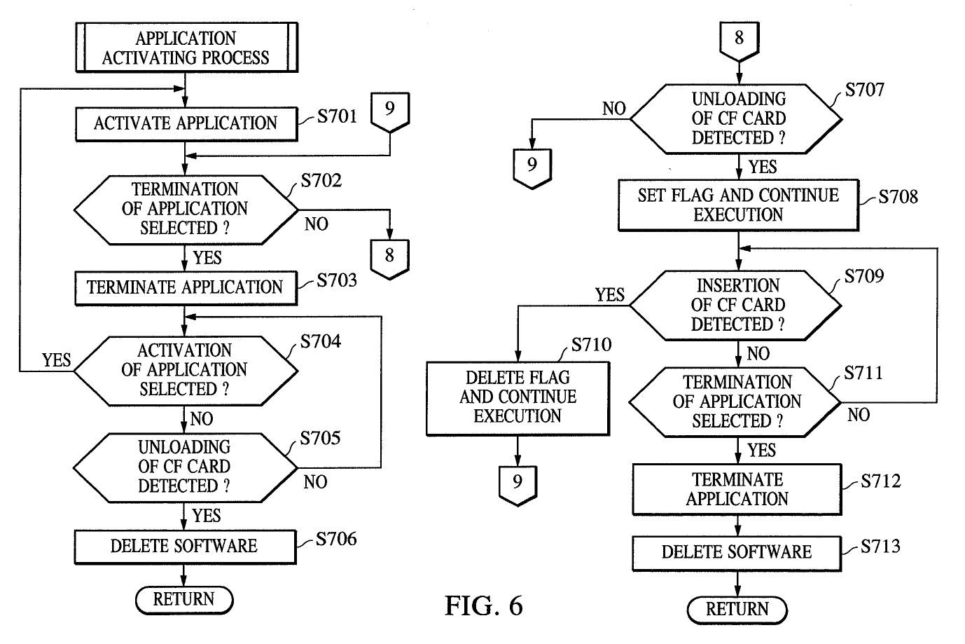

In the first embodiment, when the CF card 202 is unloaded while the application is being executed, the execution of the application is interrupted. However, in another technique, the application may be deleted after execution of the application is continued and is terminated. The flowchart of this case is shown in FIG. 6.

In FIG. 6, step S701 is identical to the step S201 shown in FIG. 4, and steps S702 up to S706 are identical to steps S202 up to S206 shown in FIG. 4, respectively. Accordingly, a description of each step is omitted.

When the user unloads the CF card 202 while the application is being executed, the unloading of the CF card 202 is detected in step S707, and in step S708, a flag indicating the unloading of the CF card 202 is set and the application is continuously executed. When the user inserts the CF card 202, the insertion of the CF card 202 is detected in step S709. In step S710, the flag indicating the unloading is deleted, and the process goes back to step S702.

When the user operates the mouse to select termination of the application without inserting the CF card 202 after step S708, the insertion of the CF card 202 is not detected in step S709, and the termination of the application is selected by the user in step S711, so that in step S712 the application is terminated. After that, because the flag has been set, the application is deleted from the internal storage 205 in step S713, and the process goes back for termination. Processing up to the activation of the application is identical to that in FIG. 3.

### Third Embodiment

In the first and second embodiments, when the CF card 202 is unloaded from the information processing device 201, the application is deleted from the internal storage 205. However, by deleting only an option for executing the application without deleting the application itself, the user may be prevented from activating the application. This is a third embodiment of the present invention, which is described below.

In the third embodiment, the physical structure of an information processing device is identical to the system structure shown in FIG. 1. Also, a process performed between the user, the store 400, and the software provider 300 is identical to that shown in FIG. 2.

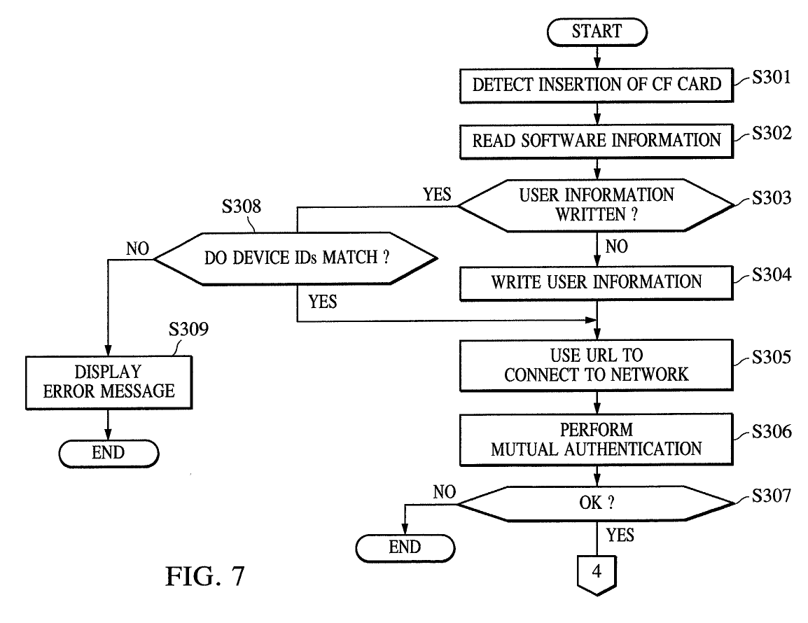

With reference to FIGS. 7 to 10, a program downloading process of the third embodiment is described below.

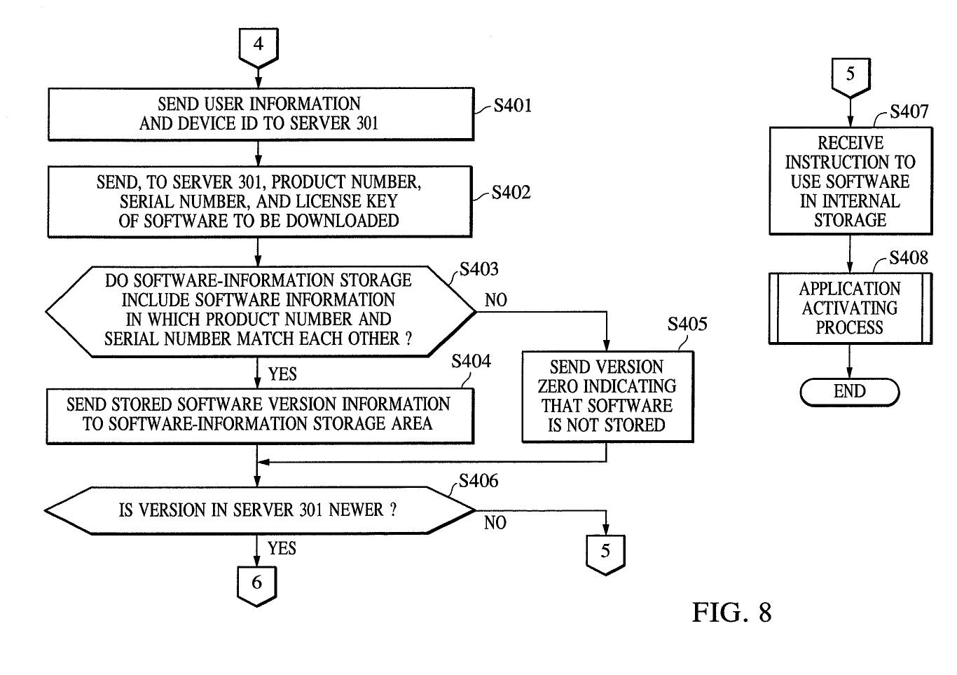

FIG. 7 shows a process from loading of the CF card 202, which is purchased by the user, into the information processing device 201 up to mutual authentication with the server 301. This process is almost identical to the process shown in FIG. 5 in the first embodiment, but differs only in that a case in which mutual authentication has been confirmed (“OK”) is shown in FIG. 8. Since the other steps are identical to the corresponding steps shown in FIG. 5, a description of each step is omitted.

The flowchart shown in FIG. 8 is described below.

After the CF card 202 and the server 301 authenticate each other by using the manufacturer authentication information written in the CF card 202 and the authentication information in the server 301, the user information and the device ID are sent to the sever 301 in step S401. The server 301 stores the received information in the user-management-information database 302 (in FIG. 2). The server 301 may perform additional checking based on the received information, as required. In this embodiment, the server 301 checks nothing in particular, so the process proceeds to step S402.

In step S402, a product code, a serial number, and a license key are sent as software information on downloading to the server 301. The server 301 checks the received information by querying a software-managementin-formation database 304. If the received information is correct, the process is continued. In step S403, the process determines whether or not the software-information storage area of the internal storage 205 (in FIG. 2) includes software information in which a product number matches a serial number. If software has already been downloaded, the software-information storage area includes the information and, in step S404, software-version information is sent to the server 301. If the software has never been downloaded, the software-information storage area does not include the information and, in step S405, “version zeros” indicating that the software-information storage area does not include the information is sent to the server 301.

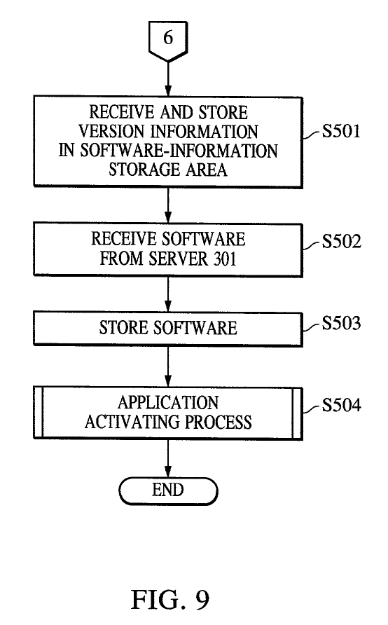

In step S406, the server 301 compares the received version and the version of software stored in the server 301. When the version of the software in the server 301 is not newer, an instruction to use software in the internal storage 205 is sent from the server 301. In step S407, the instruction is received by the information processing device 201. In step S408, an application activating process is performed in which the software in the internal storage 205 is activated. When the version of the software in the server 301 is newer, the process shown in FIG. 9 starts.

FIG. 9 shows the rest of the downloading process performed when the version of the software in the server 301 is newer. The server 301 (in FIG. 2) transmits, to the information processing device 201, version information stored in the software-management-information database 304.

In step S501, the version information is received from the server 301 and is stored in the software-information storage area by the information processing device 201. The server 301 transmits, to the information processing device 201, software stored in the file server 303. In step S502, the software is received by the information processing device 201. In step S503, the received software is stored in the downloaded software storage area 5 (in FIG. 1). After the downloading ends, an application activating process starts in step S504.

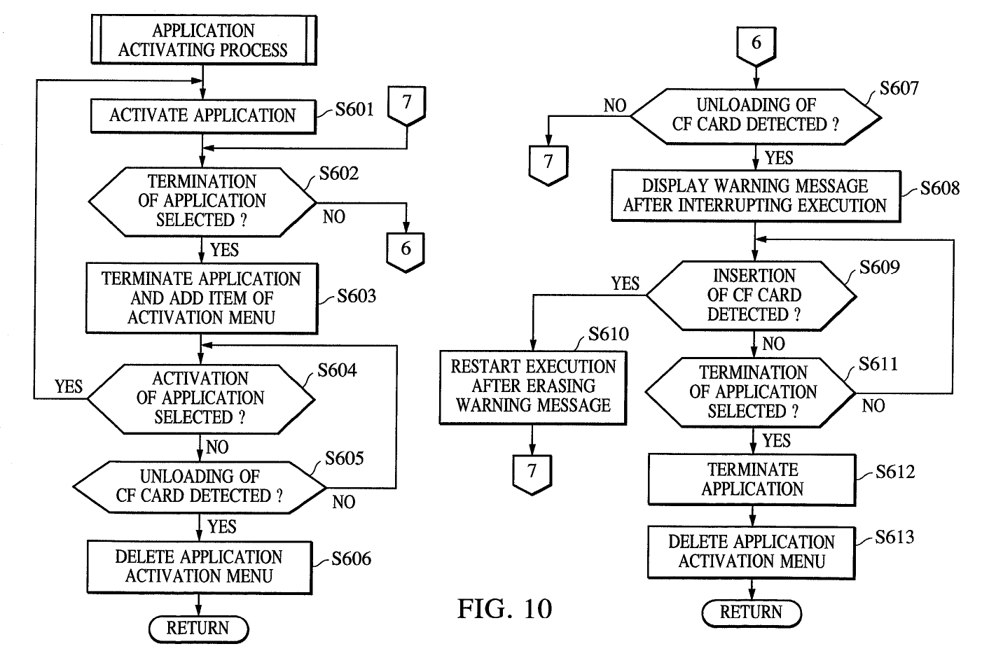

FIG. 10 shows the application activating process. After the software stored in the internal storage 5 (in FIG. 1) is loaded into memory, an application of the software is activated in step S601. The user operates the mouse to operate the application while viewing a screen displayed on the monitor.

When the user operates the mouse to select termination of the application in step S602, in step S603, an option for activating the application is added to a menu screen displayed on the monitor.

After that, when the user operates the mouse to select activation of the application from the displayed menu screen again, the process goes back to step S601, and the application is activated. When the user unloads the CF card 202 without selecting activation of the application again, the process determines, in step S605, whether or not unloading of the CF card 202 is detected. If unloading of the CF card 202 is detected, in step S606, the application activating option is deleted from the menu so that the application cannot be activated, and the process goes back for termination.

When termination of the application is not selected in step S602, the application is in being continuously used. If unloading of the CF card 202 is not detected, steps S602 through step S607 are repeatedly performed.

When the user unloads the CF card 202 while the application is being used, the unloading of the CF card 202 is detected in step S607. In step S608, after execution of the application is interrupted, a warning message warning the user either to insert the CF card 202 or to terminate the application is displayed on the monitor, and a user-input-awaiting state is activated.

When the user inserts the CF card 202, the insertion of the CF card 202 is detected in step S609. In step S610, the warning message is deleted, and execution of the application is restarted in step S610. The process goes back to step S602.

When the user operates the mouse to select termination of the application without inserting the CF card 202 after step S608, insertion of the CF card 202 is not detected in step S609 and, in step S611, it is determined whether or not termination of the application is selected. If termination of the application is selected, the application is terminated in step S612. In step S613, the application activating option is deleted from the displayed menu, and the process goes back for termination.

### Fourth Embodiment

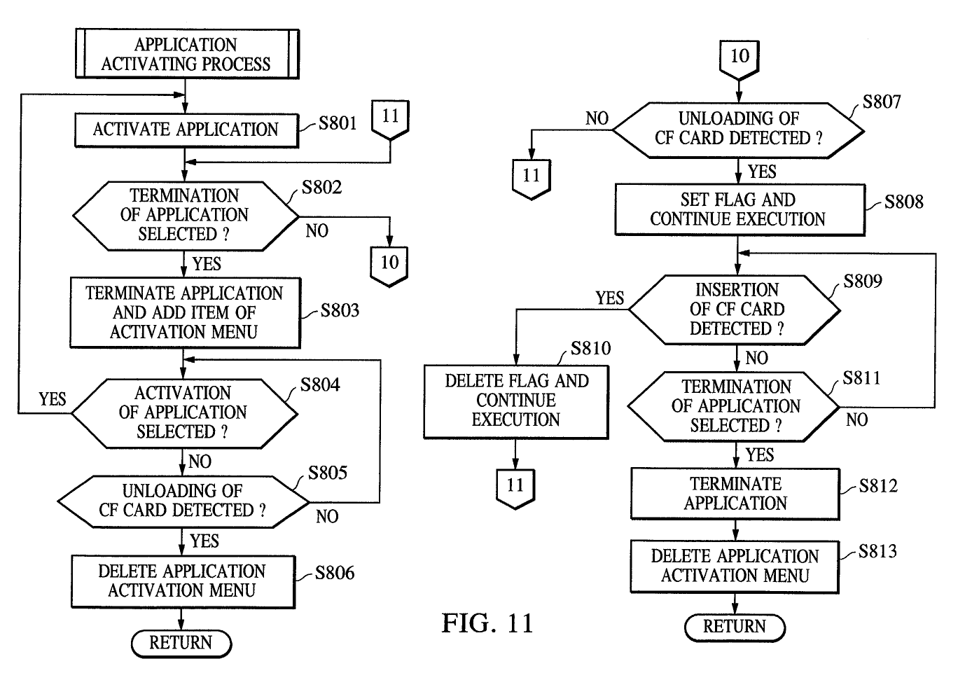

In the above third embodiment, when the CF card 202 is unloaded from the information processing device 201 while the application is being executed, execution of the application is interrupted. However, in another technique, the application activating option may be deleted after execution of the application is continued without being interrupted, and is terminated. The flowchart of this case is shown in FIG. 11.

With reference to FIG. 11, a fourth embodiment of the present invention is described below.

Step S801 in FIG. 11 is identical to step S601 in FIG. 10, and steps S802 to S806 are identical to steps S602 to S606, respectively. Accordingly, a description of each step is omitted.

When the user unloads the CF card 202 while the application is being executed, the unloading of the CF card 202 is detected in step S807. In step S808, a flag indicating that the CF card 202 has been unloaded is set, and execution of the application is continued. If the user inserts the CF card 202, the insertion of the CF card 202 is detected in step S809. In step S810, the flag is deleted and execution of the application is continued. After that, the process goes back to step S802.

When the user operates the mouse to select termination of the application without inserting the CF card 202 after step S808, insertion of the CF card 202 is not detected in step S809 and, in S811, termination of the application is selected by the user. In step S812, the application is terminated.

After that, because the flag has been set, the application activating option is deleted from the displayed menu in step S813, and the process goes back for termination. In FIG. 11, steps up to the activation of the application is are identical to those in FIGS. 7 to 9.

### Other Embodiments of the Present Invention

Components as described in the foregoing embodiments each include a central processing unit or a microprocessor unit, a random access memory (RAM), and a read-only memory (ROM) of a computer. Thus, the components can be implemented such that a program stored in the RAM or the ROM operates. Accordingly, by recording in a recording medium, such as a CD-ROM, a program for controlling the computer to perform the functions, and loading the program into the computer, the components can be implemented. Not only a CD-ROM, but also a floppy disk, a hard disk, a magnetic tape, an magneto-optical disk, a non-volatile memory card, and the like, can be used as the recording medium.

The embodiments of the present invention include, in addition to a case in which the functions of the foregoing embodiments are implemented such that a computer executes a supplied program, a case in which the functions of the foregoing embodiments are implemented such that the program operates in cooperation with an operating system of the computer or with other application software, and a case in which the functions of the foregoing embodiments are implemented such that all or part of a process based on the supplied program is performed by an add-in board or an add-in unit for the computer.

In addition, all or part of the program may be executed by another computer so that the present invention can be used in network environments. For example, a screen input process may be performed by a remote terminal computer, and various types of determination, logging, etc., may be performed by another computer such as a central computer.

As described above, according to the present invention, a right-to-use software can be sold by using a small-capacity, low-cost, portable information storage medium, and the software can be executed after being automatically downloaded from a server terminal, without requesting a user's operation.

According to another feature of the present invention, software is deleted when a portable information storage medium is unloaded. This enables only a person who possesses the portable information storage medium to execute the software, and unauthorized execution of the software can be prevented.

According to another feature of the present invention, by writing the device ID of each device into each portable information storage medium, the correspondence between the device and the software of the portable information storage medium can be established. This can prevent unauthorized use of the portable information storage medium, even if it is lost or stolen.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A portable information storage medium loadable into an information processing device connected to a network, the information processing device adapted to execute software downloaded from the network, said portable information storage medium including a storage area for storing software information including:
identification information on the software;
location information representing a location on the network at which the software is stored; and
secret information on a user who uses the software.

2. A portable information storage medium according to claim 1, wherein, in the storage area, one or more of a product code, a version number, information on the location on the network of the software, and a license key, which includes a serial number and which indicates that the user is an authorized purchaser, are stored as the software information.

3. An information processing device comprising:
a communication unit adapted to communicate with a server terminal on a network;
a portable-information-storage-medium connection unit to which a portable information storage medium storing information on software to be acquired via the network is connected;
an information transfer unit adapted to download the software from the server terminal into an internal storage medium by using said communication unit;
a software storage unit adapted to store, in a software storage area of the internal storage medium, the software downloaded into the internal storage medium;
a software management unit adapted to manage the software stored in the software storage area; and
an external-storage-medium reading unit adapted to read predetermined information written in the portable information storage medium when the portable information storage medium is connected to said portable-information-storage-medium connecting unit.

4. An information processing device according to claim 3, wherein, from the predetermined information read from the portable information storage medium, software identification information and location information on a location on the network of the software are extracted and managed by said software management unit.

5. An information processing device according to claim 4, wherein, based on an instruction from said software management unit, said information transfer unit uses said communication unit to access the server terminal by using the location information, and downloads, into the software storage area, software represented by the software identification information.

6. An information processing device according to claim 3, wherein said software management unit performs a software activating process for executing the software stored in the software storage area.

7. An information processing device according to claim 3, wherein, when the portable information storage medium is disconnected from said portable-information-storage-medium connecting unit, said software management unit performs a deletion process for deleting the software stored in the software storage area.

8. An information processing device according to claim 3, wherein, when the portable information storage medium is disconnected from said portable-information-storage-medium connecting unit while the software stored in the software storage area is being executed, said software management unit performs a medium-unloading warning process, for warning a user by interrupting execution of the software stored in the software storage area, and a user-input accepting process, for activating a user-input accepting state after the medium-unloading warning process is performed.

9. An information processing device according to claim 8, wherein, when the portable information storage medium is connected again after the medium-unloading warning process is performed, said software management unit performs an execution restarting process for restarting execution of the software.

10. An information processing device according to claim 8, wherein, when the user selects termination of execution of the software in the user-input accepting state, said software management unit terminates execution of the software, and subsequently performs a software deletion process.

11. An information processing device according to claim 3, wherein, when the portable information storage medium is disconnected from said portable-information-storage-medium connecting unit while the software is being executed, said software management unit continues execution of the software, and, when execution of the software is subsequently terminated by a user, said software management unit performs a process for deleting the software from the internal storage medium.

12. An information processing device according to claim 3, wherein:
the internal storage medium includes a nonvolatile memory, a volatile memory, and internal storage;
said software management unit stores a device identification in the nonvolatile memory and stores user information, which is written by a user, in the internal storage; and
after the portable information storage medium is loaded into said information processing device, said software management unit examines whether or not the device identification and the user information are written in the portable information storage medium, and, when the device identification and the user information are not written, said software management unit writes the device identification and the user information into the portable information storage medium.

13. An information processing device according to claim 12, wherein, after the portable information storage medium is loaded into said information processing device, said software management unit examines whether or not the device identification and the user information are written in the portable information storage medium, and, when the device identification and the user information are written, and said software management unit finds, by comparing a device identification stored internally in said information processing device and the device identification written in the portable information storage medium, identity between both device identifications, said software management unit initiates accessing of the server terminal.

14. An information processing device according to claim 4, wherein, when software represented by the software identification information is not downloaded into the software storage area, said software management unit executes a process for downloading the software into the software storage area.

15. An information processing device according to claim 14, wherein, after the software is downloaded into the software storage area, said software management unit performs a process for executing the downloaded software.

16. An information processing device according to claim 4, wherein:
when software represented by the software identification information is downloaded into the software storage area, said software management unit performs a process for comparing a version of software stored in said server terminal and a version of software stored in the software storage area;
said software management unit performs a process for initiating execution of the software in the software storage area when both versions match each other; and
when the version of the software stored in the server terminal is newer than the version in the software storage area, said software management unit performs a process that, after downloading the software from the server terminal into the software storage area, initiates execution of the downloaded software.

17. An information processing device according to claim 3, wherein:
when the software is terminated while the portable information storage medium is being loaded into said portable-information-storage-medium connecting unit, said software management unit displays, on a menu screen, an option for reactivating the software so that the software can be reactivated by input from a user; and
when the portable information storage medium is unloaded after the software is terminated, said software management unit performs a process for deleting the option for reactivating the software from the menu screen so that reactivation of the software cannot be performed in response to input from a user.

18. An information processing device according to claim 8, wherein, when the portable information storage medium is disconnected while the software is being executed, said software management unit performs a process for interrupting execution of the software, and, when the portable information storage medium is subsequently connected again after performing the warning process and activating the user-input accepting state, said software management unit executes a process for restarting execution of the software.

19. An information processing device according to claim 8, wherein, when a user selects termination of execution of the software in the user-input accepting state, said software management unit performs a process for terminating execution of the software, a process for deleting an option for reactivating the software from a menu screen, and a process for preventing reactivation of the software in response to input from a user.

20. An information processing device according to claim 3, wherein, when the portable information storage medium is unloaded while the software is being executed, said software management unit continues execution of the software, and, when a user terminates execution of the software, said software management unit performs a process for deleting an option for reactivating the software from a menu screen, so that reactivation of the software cannot be performed in response to input from a user.

21. A software distribution system for distributing software to a user, said system comprising a software provider and a store, wherein:
said software provider includes a server terminal, which is externally accessed via a network so that software is downloaded, a user-information-management database connected to the server terminal, and a file server terminal storing at least one type of software;
said software provider supplies said store with a portable information storage medium that includes a right of use of the software and information on a location on the network of the software;
said store sells the portable information storage medium to the user; and
the user downloads and executes the software from said software provider after loading the purchased portable information storage medium into an information processing device.

22. An information processing method comprising:
a communication step of communicating with a server terminal on a network;
a portable-information-storage-medium connection step of connecting to a portable information storage medium storing information on software to be acquired via the network;
an information transfer step of downloading the software from the server terminal into an internal storage medium;
a software storage step of storing, in a software storage area of the internal storage medium, the software downloaded into said internal storage medium;
a software management step of managing the software stored in the software storage area; and
an external-storage-medium reading step for reading predetermined information written in the portable information storage medium when the portable information storage medium is connected in said portable-information-storage-medium connection step.

23. A computer-readable storage medium storing a program for controlling a computer to execute an information processing method as set forth in claim 22.
